(19) United States
(12) Patent Application Publication
(10) Pub. No.: US 2024/0045314 A1
(43) Pub. Date: Feb. 8, 2024

(54) PROJECTION LENS, CONTROL METHOD OF PROJECTION LENS AND PROJECTION DEVICE

(71) Applicant: Coretronic Corporation, Hsin-Chu (TW)

(72) Inventors: Pen-Ning Kuo, Hsin-Chu (TW); Wen-Ching Ho, Hsin-Chu (TW)

(73) Assignee: Coretronic Corporation, Hsin-Chu (TW)

(21) Appl. No.: 18/365,227

(22) Filed: Aug. 4, 2023

(30) Foreign Application Priority Data
Aug. 8, 2022 (CN) 202210942417.4

(51) Int. Cl. G03B 21/14

(52) U.S. Cl. CPC G03B 21/142

(57) ABSTRACT

A projection lens, a control method thereof, and a projection device are provided. The projection lens is adapted for the projection device, and includes a lens body including an aperture assembly and a lens element group; an aperture adjustment module disposed on the lens body, connected to the aperture assembly, and configured to adjust the aperture assembly; a lens element adjustment module disposed on the lens body, connected to the lens element group, and configured to adjust the lens element group; and a switching assembly coupled to the aperture adjustment module and the lens element adjustment module. The switching assembly is configured to switch to a first state, so that the lens element adjustment module adjusts the lens element group, and the switching assembly is configured to switch to a second state, so that the aperture adjustment module group adjusts the aperture assembly.

### CROSS-REFERENCE TO RELATED APPLICATION

This application claims the priority benefit of Chinese application no. 202210942417.4, filed on Aug. 8, 2022. The entirety of the above-mentioned patent application is hereby incorporated by reference herein and made a part of this specification.

### BACKGROUND

### Technical Field

The invention relates to an optical assembly, a control method of the optical assembly and an optical device, and particularly relates to a projection lens, a control method of the projection lens and a projection device.

### Description of Related Art

As projection technology gradually develops toward maturity, consumers' requirements on quality of projection images of a projection device are also increasing. Since a projection lens with a fixed aperture cannot meet consumers' application requirements on high brightness and high contrast of projection images, a projection lens with a variable aperture is required. However, if an aperture adjustment module is added, additional arrangement space and wiring are required, and elements of the projection lens are required to be redesigned and rearranged, which is thus not cost-effective.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a projection lens, a control method of a projection lens, and a projection device, where the projection lens is capable of controlling both an aperture adjustment module and a lens element adjustment module.

Other objectives and advantages of the invention may be further illustrated by the technical features broadly embodied and described as follows.

In order to achieve one, some, or all of the objectives above or other objectives, an embodiment of the invention provides a projection lens. The projection lens is adapted for a projection device, and the projection lens includes a lens body, an aperture adjustment module, a lens element adjustment module, and a switching assembly. The lens body includes an aperture assembly and a lens element group. The aperture adjustment module is disposed on the lens body and connected to the aperture assembly, and the aperture adjustment module is configured to adjust the aperture assembly. The lens element adjustment module is disposed on the lens body and connected to the lens element group, and the lens element adjustment module is configured to adjust the lens element group. The switching assembly is coupled to the aperture adjustment module and the lens element adjustment module. The switching assembly is configured to switch to a first state so that the lens element adjustment module adjusts the lens element group, and the switching assembly is configured to switch to a second state so that the aperture adjustment module group adjusts the aperture assembly.

In an embodiment of the invention, the lens element adjustment module is a zoom module or a focus module.

In an embodiment of the invention, the switching assembly includes a signal receiving unit, a control unit, and a switching unit. The signal receiving unit is configured to receive a control signal, the control unit is coupled to the signal receiving unit and the switching unit, and the control unit is configured to control the switching unit to switch to the first state or the second state according to the control signal.

In an embodiment of the invention, the projection lens further includes a processor coupled to the switching assembly, the lens element adjustment module, and the aperture adjustment module, and the processor is configured to control the lens element adjustment module and the aperture adjustment module according to the control signal.

In an embodiment of the invention, the lens body further includes an electrical connection interface, the electrical connection interface has an electrical contact, the electrical contact is coupled to the processor, the switching assembly is coupled to the processor through the electrical contact, and the lens element adjustment module is coupled to the processor through the switching assembly and the electrical contact. The aperture adjustment module is coupled to the processor through the switching assembly and the electrical contact.

In an embodiment of the invention, the control signal includes a state signal and an adjustment signal, the switching assembly is configured to switch to the first state or the second state according to the state signal, the switching assembly is further configured to transmit the adjustment signal to the processor, and the processor controls the lens element adjustment module to adjust the lens element group or controls the aperture adjustment module to adjust the aperture assembly according to the adjustment signal.

In an embodiment of the invention, the aperture adjustment module includes an actuating element and a linkage mechanism. The actuating element is disposed on the lens body and coupled to the switching assembly, and the linkage mechanism is disposed on the lens body and connected between the actuating element and the aperture assembly.

In an embodiment of the invention, the linkage mechanism includes a first gear, a rack, and a rod. The first gear is connected to the actuating element and meshes with the rack, and the rod is connected between the rack and the aperture assembly.

In an embodiment of the invention, the lens body has an optical axis, the rack is arc-shaped, and the rack extends on the lens body about the optical axis.

In an embodiment of the invention, the lens body further includes a first rail portion, the rack has a second rail portion, and the first rail portion and the second rail portion slide relative to each other.

In an embodiment of the invention, the rack has a tooth portion at one side and a connecting hole at another side, the tooth portion meshes with the first gear, and the rod is disposed through the connecting hole.

In an embodiment of the invention, the aperture adjustment module includes a sensing element and a second gear, the second gear is connected to the sensing element and meshes with the rack, and the sensing element is configured to sense a position of the aperture assembly.

In an embodiment of the invention, the projection lens further includes a display unit coupled to the switching assembly, and the display unit is configured to display whether the switching assembly is in the first state or in the second state.

In order to achieve one, some, or all of the objectives above or other objectives, an embodiment of the invention provides a control method of a projection lens, which includes following steps. A control signal is received by a switching assembly, where the control signal is a first control signal or a second control signal. The switching assembly is switched to a first state according to the first control signal so that a lens element adjustment module adjusts a lens element group of a lens body. The switching assembly is switched to a second state according to the second control signal so that an aperture adjustment module adjusts an aperture assembly of the lens body.

In an embodiment of the invention, the switching assembly includes a signal receiving unit, a control unit, and a switching unit. The control method further includes following steps. The first control signal or the second control signal is received by the signal receiving unit. The control unit controls the switching unit to switch to the first state according to the first control signal. The control unit controls the switching unit to switch to the second state according to the second control signal.

In an embodiment of the invention, the signal receiving unit receives the control signal by wireless transmission.

In an embodiment of the invention, the signal receiving unit receives the control signal from an Internet of things device.

In an embodiment of the invention, the projection lens further includes a processor, and the control method further includes following steps. The control signal is transmitted to the processor through the switching assembly. The processor controls the lens element adjustment module to adjust the lens element group or controls the aperture adjustment module to adjust the aperture assembly according to the control signal.

In an embodiment of the invention, the switching assembly receives the control signal from the processor.

In an embodiment of the invention, the aperture adjustment module includes a sensing element, and the control method further includes a following step. A position of the aperture assembly is sensed by the sensing element.

In an embodiment of the invention, the projection lens further includes a display unit, and the control method further includes a following step. Whether the switching assembly is in the first state or in the second state is displayed by the display unit.

In order to achieve one, some, or all of the objects above or other objectives, an embodiment of the invention provides a projection device including a light source, a light valve and a projection lens. The light source is configured to provide an illumination beam. The light valve is configured to convert the illumination beam into an image beam. The projection lens is configured to project the image beam out of the projection device, and the projection lens includes a lens body, an aperture adjustment module, a lens element adjustment module and a switching assembly. The lens body includes an aperture assembly and a lens element group. The aperture adjustment module is disposed on the lens body and connected to the aperture assembly, and the aperture adjustment module is configured to adjust the aperture assembly. The lens element adjustment module is disposed on the lens body and connected to the lens element group, and the lens element adjustment module is configured to adjust the lens element group. The switching assembly is coupled to the aperture adjustment module and the lens element adjustment module. The switching assembly is configured to switch to a first state so that the lens element adjustment module adjusts the lens element group, and the switching assembly is configured to switch to a second state so that the aperture adjustment module group adjusts the aperture assembly. In an embodiment of the invention, the lens element adjustment module is a zoom module or a focus module.

In an embodiment of the invention, the switching assembly includes a signal receiving unit, a control unit, and a switching unit. The signal receiving unit is configured to receive a control signal, the control unit is coupled to the signal receiving unit and the switching unit, and the control unit is configured to control the switching unit to switch to the first state or the second state according to the control signal.

In an embodiment of the invention, the projection lens further includes a processor coupled to the switching assembly, the lens element adjustment module, and the aperture adjustment module, and the processor is configured to control the lens element adjustment module and the aperture adjustment module according to the control signal.

In an embodiment of the invention, the lens body further includes an electrical connection interface, the electrical connection interface has an electrical contact, the electrical contact is coupled to the switching assembly, the switching assembly is coupled to the processor through the electrical contact, the lens element adjustment module is coupled to the processor through the switching assembly and the electrical contact, and the aperture adjustment module is coupled to the processor through the switching assembly and the electrical contact.

Based on the above description, the embodiments of the invention have at least one of following advantages or effects. The projection lens of the embodiment of the invention is provided with a switching assembly, and the switching assembly may be used to switch between the lens element adjustment module and the aperture adjustment module. Accordingly, the lens element adjustment module and the aperture adjustment module may share the electrical contacts of the electrical connection interface of the lens body, so that the projection lens may control both of the aperture adjustment module and the lens element adjustment module through the existing electrical connection interface.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the invention.

FIG. 2 is a three-dimensional view of a projection lens of FIG. 1.

FIG. 3 is a schematic diagram of some components of the projection lens of FIG. 2.

FIG. 4 is a flowchart of a control method of a projection lens according to an embodiment of the invention.

FIG. 5A illustrates a transmission method of a control signal of FIG. 3.

FIG. 5B illustrates a transmission method of a control signal according to another embodiment of the invention.

FIG. 5C illustrates a transmission method of a control signal according to another embodiment of the invention.

FIG. 6 is an exploded view of the projection lens of FIG. 2.

FIG. 7 is a partial side view of the projection lens of FIG. 2.

FIG. 8 is a cross-sectional view of the projection lens of FIG. 7 viewing along a line I-I.

FIG. 9 is a partial top view of the projection lens of FIG. 2.

FIG. 10 is a partial cross-sectional view of the projection lens of FIG. 9 viewing along a line II-II.

FIG. 11 illustrates a part of steps of a control method of a projection lens according to some embodiments of the invention.

FIG. 12 illustrates another part of steps of the control method of the projection lens according to some embodiments of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top, ” “bottom, ” “front, ” “back, ” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

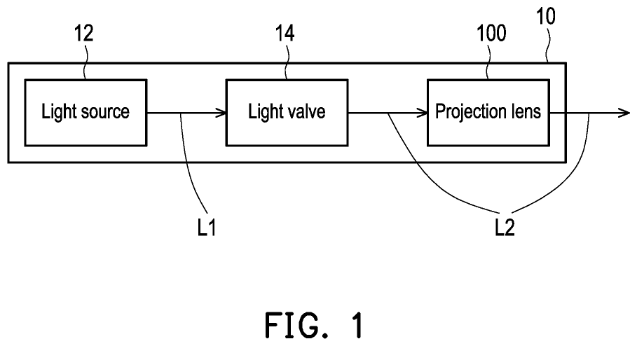

FIG. 1 is a schematic diagram of a projection device according to an embodiment of the invention. Referring to FIG. 1, a projection device 10 of the embodiment includes a light source 12, a light valve 14 and a projection lens 100. The light source 12 is used to provide an illumination beam L1. The light valve 14 is located on a transmission path of the illumination beam L1, and the light valve 14 is used for converting the illumination beam L1 into an image beam L2. The projection lens 100 is located on a transmission path of the image beam L2, and the projection lens 100 is used to project the image beam L2 out of the projection device 10 to a projection target (not shown), such as a screen or a wall.

For example, the light source 12 includes a plurality of light emitting diodes (LEDs), laser diodes or light bulb, etc., and may be matched with other optical elements such as wavelength conversion element, light-uniforming element, filter element or multiple light splitting and combining elements, etc., according to different light sources, which is used to provide light beams with different wavelengths (colors) as a source of the illumination beam L1. The light valve 14 is, for example, a digital micro-minor device (DMD), a liquid-crystal-on-silicon panel (LCOS panel) or a spatial light modulator such as a liquid crystal panel (LCD). However, the invention does not limit the type or shape of the light source 12 and the light valve 14 in the projection device 10, and the detailed structure and implementation thereof may be designed by the manufacturer, which are not repeated.

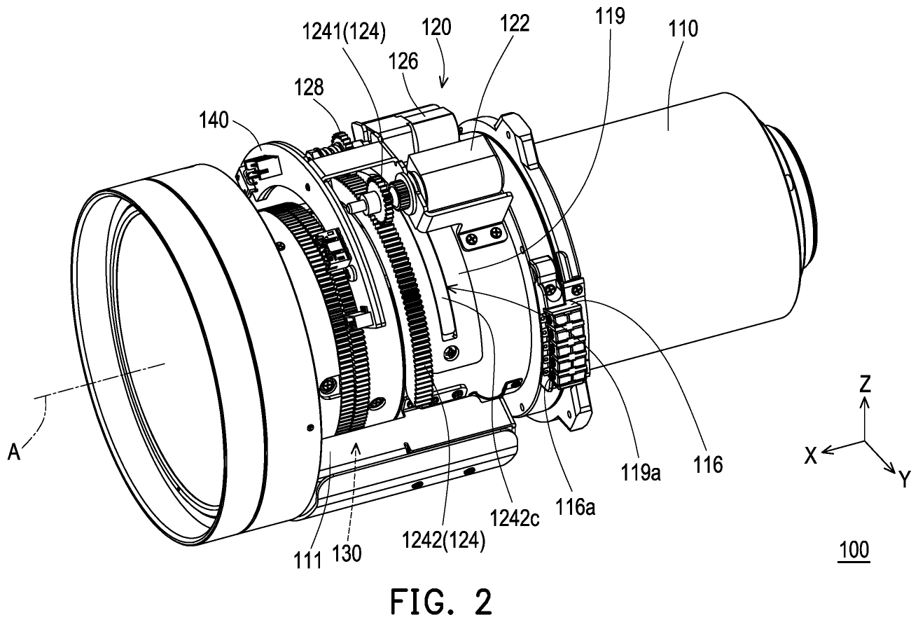

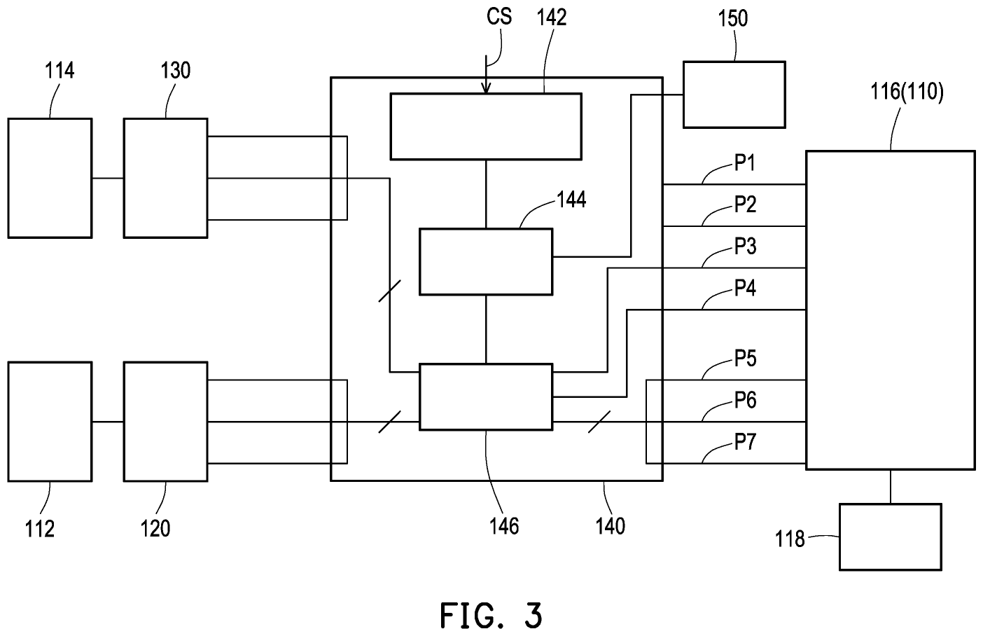

FIG. 2 is a three-dimensional view of the projection lens of FIG. 1. FIG. 3 is a schematic diagram of some components of the projection lens of FIG. 2. Referring to FIG. 2 and FIG. 3, the projection lens 100 of the embodiment includes a lens body 110, an aperture adjustment module 120 and at least one lens element adjustment module 130. The lens body 110 includes an aperture assembly 112, a lens element group 114 and an electrical connection interface 116. The aperture adjustment module 120 is disposed on the lens body 110, and the aperture adjustment module 120 is connected to the aperture assembly 112. The aperture adjustment module 120 is used for adjusting an aperture size of the aperture assembly 112. The lens element adjustment module 130 is disposed on the lens body 110, and the lens element adjustment module 130 is connected to the lens element group 114. The lens element adjustment module 130 may include at least one of a zoom module and a focus module, which is used to perform zoom adjustment and/or focus adjustment on the lens element group 114.

As shown in FIG. 2, the electrical connection interface 116 has a plurality of electrical contacts (one of the electrical contacts 116a is schematically indicated in FIG. 2). As shown in FIG. 3, the projection lens 100 further includes a switching assembly 140. The switching assembly 140 is coupled to the lens body 110 through the plurality of electrical contacts of the electrical connection interface 116, and the lens element adjustment module 130 is coupled to the lens body 110 through the switching assembly 140 and the plurality of electrical contacts of the electrical connection interface 116, the aperture adjustment module 120 is coupled to the lens body 110 through the switching assembly 140 and the plurality of electrical contacts of the electrical connection interface 116. The switching assembly 140 is configured to switch to a first state so that the lens element adjustment module 130 adjusts the lens element group 114, and the switching assembly 140 is configured to switch to a second state so that the aperture adjustment module 120 adjusts the aperture assembly 112. The switching assembly 140 of the embodiment is disposed on the lens body 110 as shown in FIG. 2, and in another embodiment, the switching assembly 140 may be disposed in a casing of the projection device 10, for example, at a position adjacent to the light source 12 or the light valve 14, or other positions inside the casing.

As described above, the projection lens 100 of the embodiment is provided with the switching assembly 140, and the switching assembly 140 may be used to switch between the lens element adjustment module 130 and the aperture adjustment module 120. Accordingly, the lens element adjustment module 130 and the aperture adjustment module 120 may share the electrical contacts of the electrical connection interface 116 of the lens body 110 so that the projection lens 100 may control both of the aperture adjustment module 120 and the lens element adjustment module 130 through the existing electrical connection interface 116.

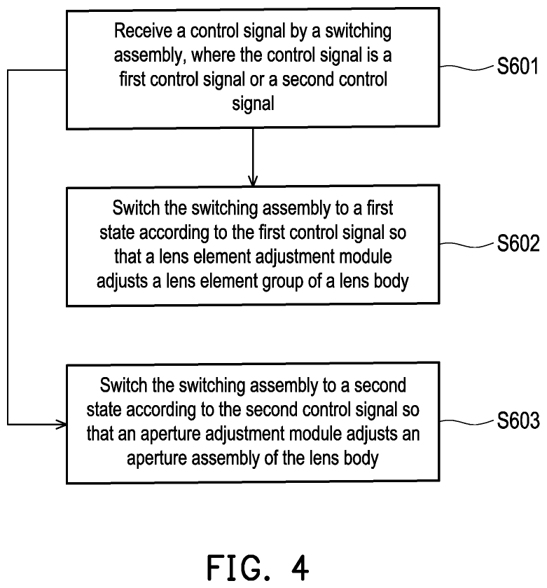

The following describes a control method of a projection lens according to an embodiment of the invention with reference to the drawings. FIG. 4 is a flowchart of a control method of a projection lens according to an embodiment of the invention. Referring to FIG. 4, first, a control signal is received by the switching assembly 140, where the control signal is a first control signal or a second control signal (step S601). The switching assembly 140 is switched to a first state according to the first control signal so that the lens element adjustment module 130 adjusts the lens element group 114 of the lens body 110 (step S602). Alternatively, the switching assembly 140 is switched to a second state according to the second control signal so that the aperture adjustment module 120 adjusts the aperture assembly 112 of the lens body 110 (step S603).

To be specific, in the embodiment, as shown in FIG. 3, the switching assembly 140 includes a signal receiving unit 142, a control unit 144 and a switching unit 146. The signal receiving unit 142 is used for receiving the first control signal or the second control signal (indicated as the control signal CS in FIG. 3) in the above-mentioned step S601. The control unit 144 is coupled to the signal receiving unit 142 and the switching unit 146. The above control method may further include the control unit 144 storing the control signal CS coming from the signal receiving unit 142. In step S602, the control unit 144 is used for storing the first control signal and controlling the switching unit 146 to switch to the first state according to the first control signal. Alternatively, in step 5603, the control unit 144 is used for storing the second control signal and controlling the switching unit 146 to switch to the second state according to the second control signal.

On the other hand, the projection lens 100 further includes a processor 118. The processor 118 is coupled to the electrical connection interface 116, and the processor 118 is coupled to the switching unit 146, the lens element adjustment module 130 and the aperture adjustment module 120 through the plurality of electrical contacts of the electrical connection interface 116. The processor 118 is used for controlling the lens element adjustment module 130 according to the first control signal in the above step S602, or controlling the aperture adjustment module 120 according to the second control signal in the above step S603. The processor 118 may include, for example, a central processing unit (CPU) with an image data processing function, or other programmable general-purpose or special-purpose microprocessors, an image processing units (IPU), a graphics processing unit (GPU), a digital signal processor (DSP), an application specific integrated circuit (ASIC), a programmable logic device (PLD), other similar operation circuits, or a combination of these circuits. In the embodiment, the processor 118 is disposed in the casing of the projection device 10. In an embodiment, the processor 118 and the processor of the projection device 10 may be the same device, and the switching assembly 140 is coupled to the processor of the projection device 10 through the electrical connection interface 116.

To be specific, the aforementioned control signal CS includes a state signal and an adjustment signal. The state signal includes state information of the projection lens 100, such as the first state or the second state. The adjustment signal includes adjustment information of the projection lens 100, such as movement information of a plurality of lens elements of the lens element group 114 in case of zooming and/or focusing adjustment, or size information of an aperture of the aperture assembly 112 when adjusting a depth of field. The switching unit 146 is used for switching to the first state or the second state according to the state signal in the control signal CS. The switching unit 146 is further configured to transmit the adjustment signal in the control signal CS to the electrical connection interface 116, and transmit the adjustment signal to the processor 118 through the electrical connection interface 116. The processor 118 controls the lens element adjustment module 130 to adjust the lens element group 114 or controls the aperture adjustment module 120 to adjust the aperture assembly 112 according to the adjustment signal.

The specific method that the switching assembly 140 receives the control signal CS is further described below.

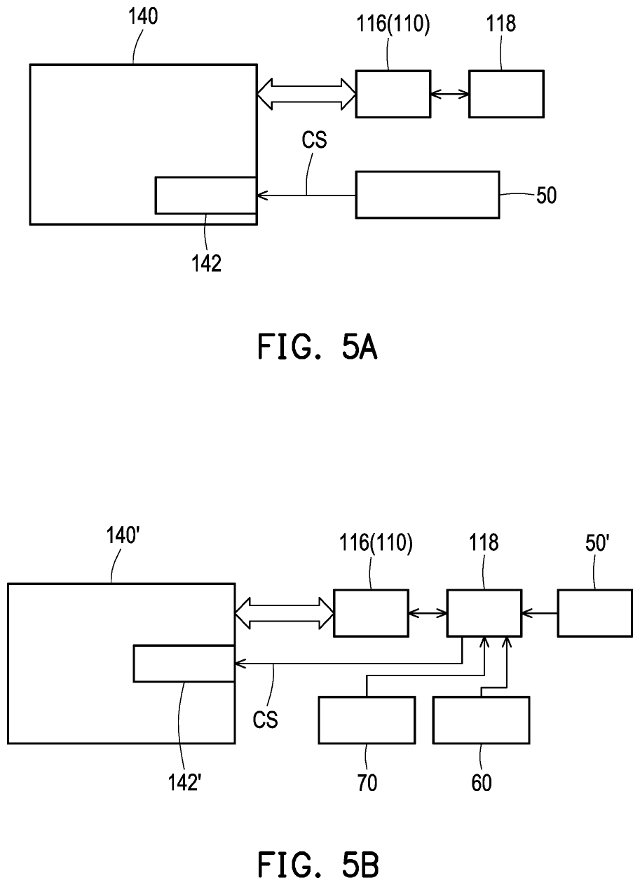

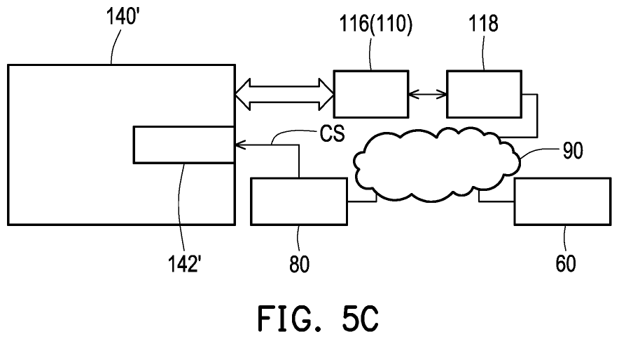

FIG. 5A illustrates a transmission method of the control signal of FIG. 3. Referring to FIG. 5A, a user may use a remote controller 50 (for example, an infrared remote controller) to remotely control the switching assembly 140. The signal receiving unit 142 of the switching assembly 140 may include a wireless receiver for receiving the control signal CS from the remote controller 50 by wireless transmission.

FIG. 5B illustrates a transmission method of a control signal according to another embodiment of the invention. Referring to FIG. 5B, a difference between the embodiment of FIG. 5B and the embodiment of FIG. 5A is that the user may use a remote controller 50′ (for example, an infrared remote controller) to remotely control the processor 118 disposed in the projection device 10, so as to transmit the control signal CS to the processor 118, where the processor 118 includes an infrared receiver. In an embodiment, the infrared receiver of the processor 118 may be an existing infrared receiver in the projection device 10. In an embodiment, the user may use an external electronic device 60 (such as a mobile phone or a computer) to transmit the control signal CS to the processor 118, or operate an on-screen display (OSD) interface of the projection device 10 to input the control signal CS to the processor 118, where the OSD interface is coupled to the processor 118. A signal receiving unit 142′ of a switching assembly 140′ may include a transmission interface such as a universal asynchronous receiver/transmitter (UART), an inter-integrated circuit (I2C), a serial peripheral interface (SPI), a universal serial bus (USB), etc., the signal receiving unit 142′ is used for receiving the control signal CS coming from the processor 118.

FIG. 5C illustrates a transmission method of a control signal according to another embodiment of the invention. Referring to FIG. 5C, a difference between the embodiment of FIG. 5C and the embodiment of FIG. 5B is that the control signal CS may come from an Internet of things (IoT) device 80. Specifically, the IoT device 80 is, for example, connected to the processor 118 and/or the external electronic device 60 (such as a mobile phone or a computer, etc.) via a cloud 90, and the control signal CS may be input to the cloud 90 by the user by using the electronic device 60, and the control signal CS is then transmitted to the IoT device 80 by the cloud 90, and then transmitted to the signal receiving unit 142′ of the switching assembly 140′. The IoT device 80 may include, for example, a communication chip, a storage device, a processor, etc.

A specific composition of the aperture adjustment module 120 of the aforementioned embodiment is described below.

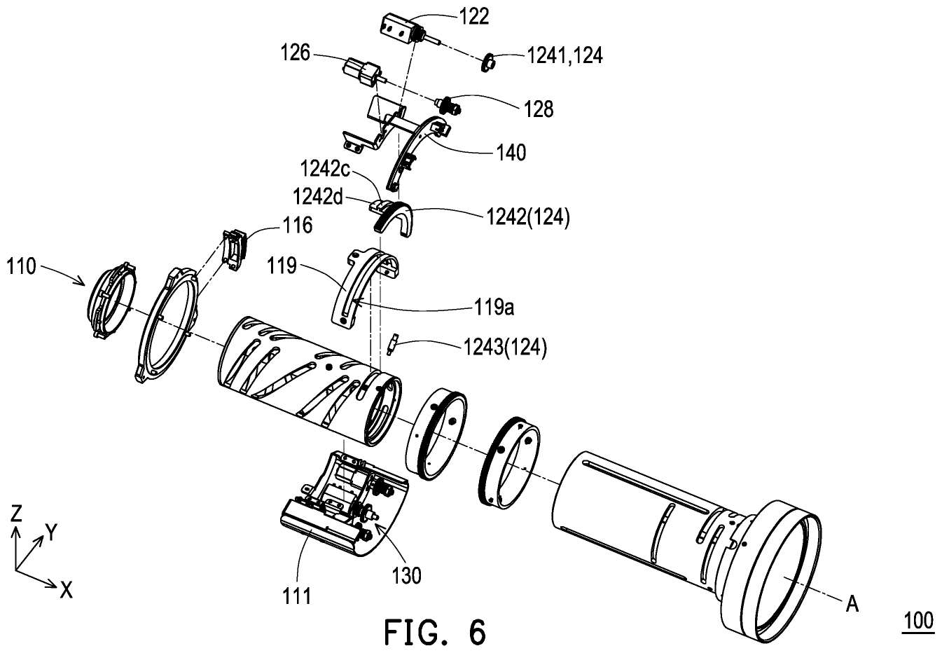

FIG. 6 is an exploded view of the projection lens of FIG. 2. Referring to FIG. 2 and FIG. 6, the aperture adjustment module 120 includes an actuating element 122 and a linkage mechanism 124. The actuating element 122 is, for example, a motor, the actuating element 122 is disposed on the lens body 110, and the actuating element 122 is coupled to the switching assembly 140. The linkage mechanism 124 is disposed on the lens body 110, and the linkage mechanism 124 is connected between the actuating element 122 and the aperture assembly 112 (shown in FIG. 3).

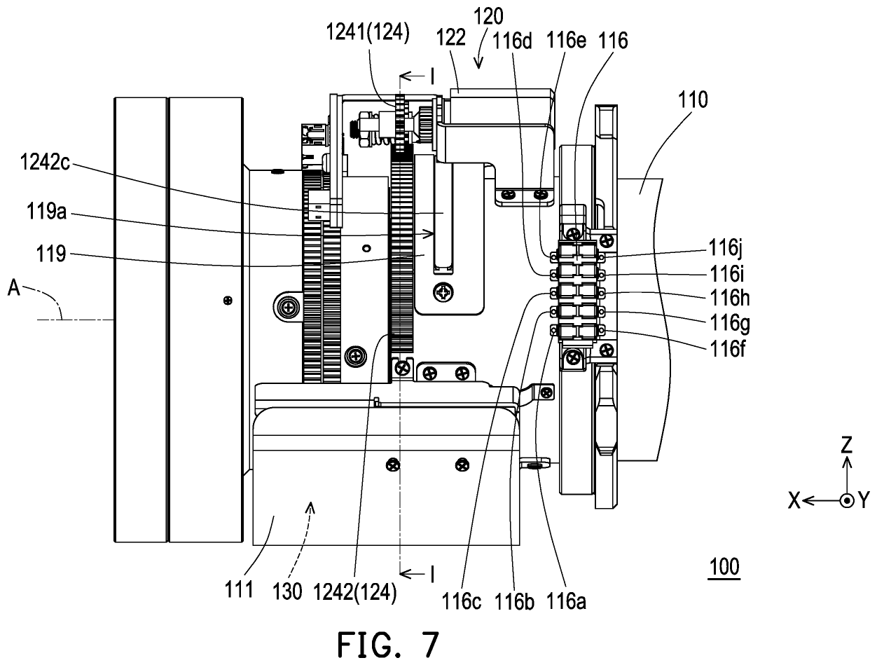

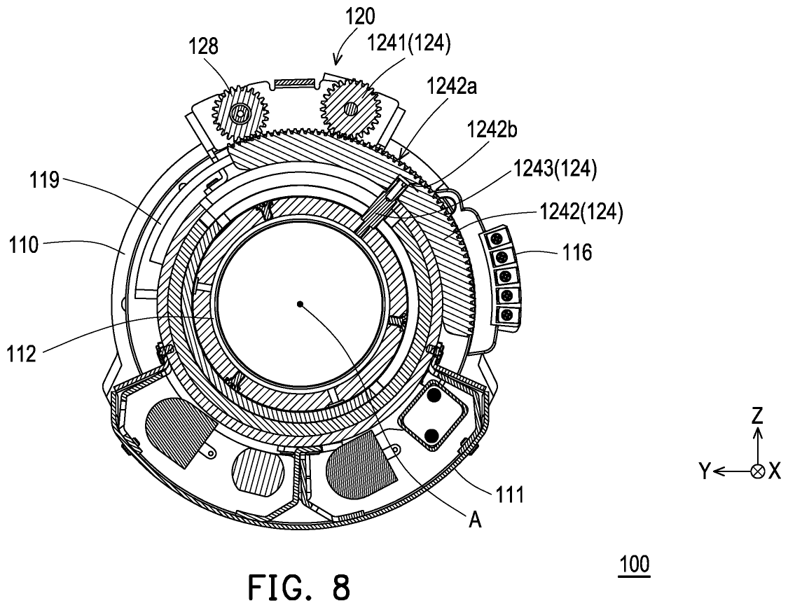

FIG. 7 is a partial side view of the projection lens of FIG. 2. FIG. 8 is a cross-sectional view of the projection lens of FIG. 7 viewing along a line I-I. Referring to FIG. 7 and FIG. 8, in detail, the linkage mechanism 124 includes a first gear 1241, a rack 1242 and a rod 1243. The rack 1242 is, for example, arc-shaped. On a reference plane perpendicular to an optical axis A, the rack 1242 extends on the lens body 110 about the optical axis A of the lens body 110, and the rack 1242 may move around the optical axis A. The first gear 1241 is connected to the actuating element 122 and meshes with the rack 1242, and the rod 1243 is connected between the rack 1242 and the aperture assembly 112. The rack 1242 has a tooth portion 1242a at one side and a connecting hole 1242b at another side, the tooth portion 1242a meshes with the first gear 1241, and the rod 1243 is disposed through the connecting hole 1242b. According to such configuration, the actuating element 122 may drive the rack 1242 to move around the optical axis A through the first gear 1241, and accordingly drive the aperture assembly 112 to actuate through the rod 1243.

Moreover, referring to FIG. 2, FIG. 6 and FIG. 8, the aperture adjustment module 120 further includes a sensing element 126 and a second gear 128. The second gear 128 is connected to the sensing element 126 and meshes with the rack 1242, and the sensing element 126 is used for sensing a position of the aperture assembly 112. Specifically, the sensing element 126 is, for example, an encoder, and is used for obtaining a sensing signal according to rotation of the second gear 128, where the sensing signal is, for example, position information of the aperture assembly 112, and the processor 118 may read the position information of the aperture assembly 112 through the electrical connection interface 116, so that the processor 118 may control the aperture adjustment module 120 to adjust the aperture assembly 112 according to the position information. In other embodiments, the sensing element 126 may be other types of sensor, such as a light sensor for sensing light flux. Similarly, the lens element adjustment module 130 may also include a corresponding sensing element for sensing a position of a focus assembly and/or a zoom assembly to obtain a sensing signal, which is used as a basis for focusing adjustment/zooming adjustment.

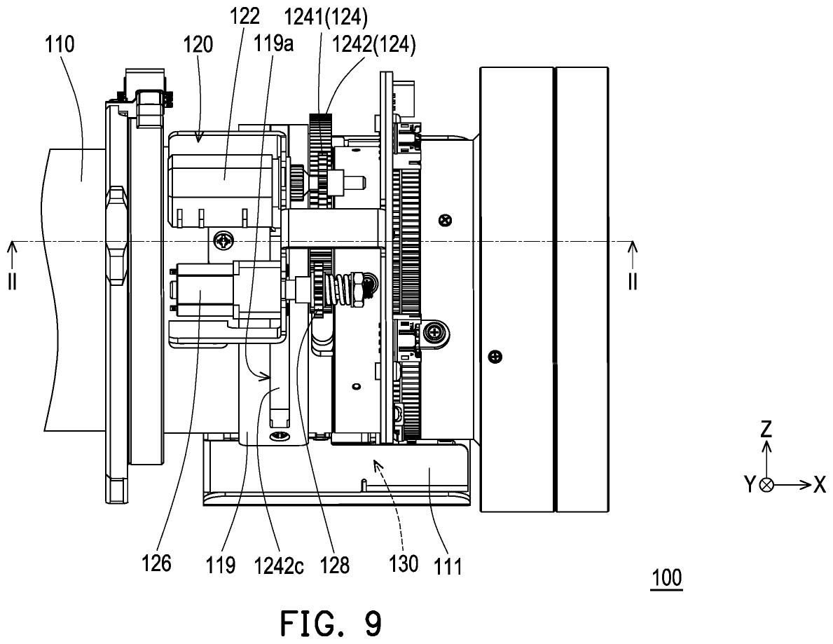

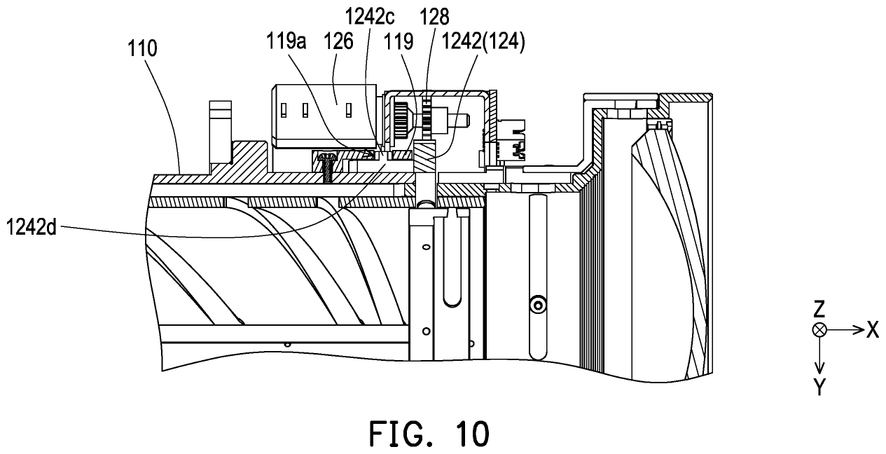

FIG. 9 is a partial top view of the projection lens of FIG. 2. FIG. 10 is a partial cross-sectional view of the projection lens of FIG. 9 viewing along a line II-II. Referring to FIG. 9 and FIG. 10, the lens body 110 further includes a first rail portion 119, and the rack 1242 has a second rail portion 1242d. The first rail portion 119 is fixed on a surface of the lens body 110, and the first rail portion 119 has a guide groove 119a. The second rail portion 1242d extends from a side surface of the rack 1242 as shown in FIG. 10, and the second rail portion 1242d has a convex portion 1242c. The first rail portion 119 limits a position of the second rail portion 1242d to the surface of the lens body 110, and the first rail portion 119 and the second rail portion 1242d may slide relative to each other through the guide groove 119a and the convex portion 1242c. Therefore, the rack 1242 may slide along the guide groove 119a through the second rail portion 1242d, as that the rack 1242 moves around the optical axis A as described above.

On the other hand, the lens element adjustment module 130 is, for example, disposed in a casing portion 111 of the lens body 110, and includes, for example, a focus motor/zoom motor and a corresponding linkage mechanism. In order to make the drawings more concise, the above-mentioned components of the lens element adjustment module 130 are not specifically shown in the drawing, which are known technologies in the art, and details thereof are not repeated here. In the embodiment, the lens element group 114 includes, for example, a combination of one or a plurality of optical lens elements with diopter, for example, various combinations of non-planar lens elements such as a biconcave lens element, a biconvex lens element, a concavo-convex lens element, a convexo-concave lens element, a plano-convex lens element, a plano-concave lens element, etc. In an embodiment, the lens element group 114 may also include planar optical lens elements. The embodiment does not limit the pattern and type of the lens element group 114.

In the aforementioned embodiment, the switching assembly 140 is connected to the electrical contacts of the electrical connection interface 116 by, for example, a wire, and the switching assembly 140 is connected to the aperture adjustment module 120 and the lens element adjustment module 130 by, for example, a wire. For clarity of the drawings, these wires are not shown in the drawings.

The electrical contacts of the electrical connection interface 116 of the aforementioned embodiments are described in detail below. Referring to FIG. 7, the electrical connection interface 116 includes a plurality of electrical contacts 116a-116j. The electrical contact 116a is, for example, used to receive a power supply signal and corresponds to a transmission path P1 in FIG. 3, and the electrical contact 116d is, for example, a ground contact corresponding to the electrical contact 116a, and corresponds to a transmission path P2 in FIG. 3. The electrical contact 116j is, for example, used to receive the aforementioned control signal CS and corresponds to a transmission path P3 in FIG. 3, and the electrical contact 116e is, for example, a ground contact corresponding to the electrical contact 116j, and corresponds to a transmission path P4 in FIG. 3. The electrical contact 116b is, for example, used to receive the sensing signal from the sensing element 126 of the aperture adjustment module 120 or a sensing signal from the sensing element of the zoom module (one of the lens element adjustment module 130), and corresponds to a transmission path P5 of FIG. 3. The electrical contact 116c is, for example, used to receive the sensing signal from the sensing element of the focus module (the other one of the lens element adjustment module 130). The electrical contacts 116f and 116g, for example, respectively correspond to the driving signal and ground contact of the aperture adjustment module 120 or the zoom module (one of the lens element adjustment module 130), and the driving signal and the ground contact respectively correspond to transmission paths P6 and P7 in FIG. 3. The electrical contacts 116h and 116i, for example, respectively correspond to the driving signal and the ground contact of the focus module (the other one of the lens element adjustment module 130).

As described above, the aperture adjustment module 120 and the zoom module (one of the lens element adjustment module 130) share the electrical contacts 116b, 116f, and 116g (corresponding to the transmission paths P5, P6, P7 in FIG. 3). In other embodiments, the aperture adjustment module 120 may be changed to share the electrical contacts 116c, 116h, and 116i with the focus module (the other one of the lens element adjustment module 130).

Detailed control steps of the aforementioned embodiments are introduced below with reference of drawings.

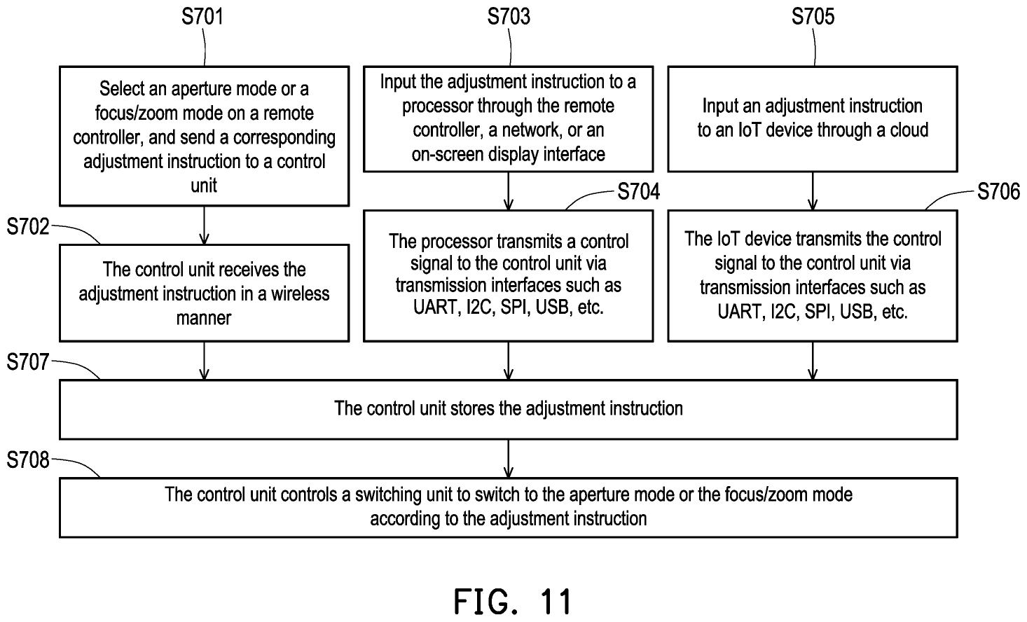

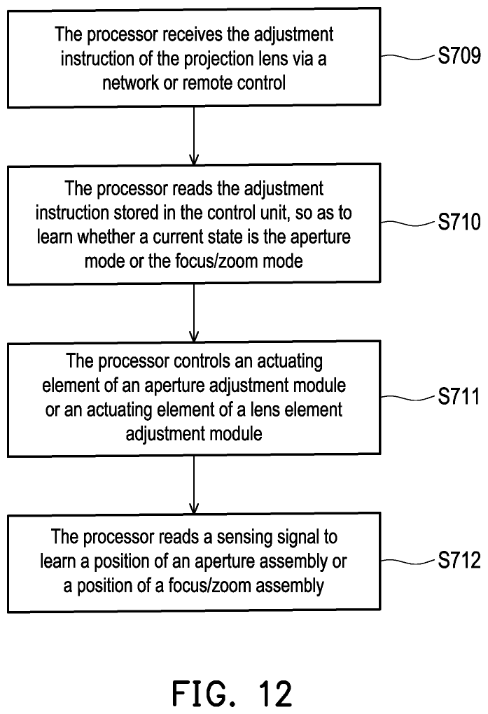

FIG. 11 illustrates a part of steps of a control method of a projection lens according to some embodiments of the invention. FIG. 12 illustrates another part of the steps of the control method of the projection lens according to some embodiments of the invention. Referring to FIG. 11, the user selects an aperture mode (corresponding to the aforementioned second state) or a focus/zoom mode (corresponding to the aforementioned first state) on the remote controller 50, and sends a corresponding adjustment instruction (corresponding to the aforementioned control signal CS) to the control unit 144 (step S701), and the control unit 144 receives the adjustment instruction in a wireless manner (step S702). Steps S701 and S702 correspond to the embodiment shown in FIG. 5A.

The user may also input the adjustment instruction (corresponding to the aforementioned control signal CS) to the processor 118 through the remote controller 50′, a network of the external device 60, or an on-screen display interface 70 (step S703). In an embodiment, the processor 118 may convert an adjustment instruction signal input by the user into the control signal CS. The processor 118 transmits the control signal CS to the control unit 144 via transmission interfaces such as the universal asynchronous receiver/transmitter, the inter-integrated circuit, the serial peripheral interface, the universal serial bus, etc., included in the signal receiving unit 142′ (step S704), where steps S703 and S704 correspond to the embodiment shown in FIG. 5B.

In addition, the user may also input an adjustment instruction (corresponding to the aforementioned control signal CS) to the IoT device 80 through the cloud 90 (step S705), and the IoT device 80 transmits the control signal CS to the control unit 144 via transmission interfaces such as the universal asynchronous receiver/transmitter, the inter-integrated circuit, the serial peripheral interface, the universal serial bus, etc., included in the signal receiving unit 142′ (step S706), where steps S705 and S706 correspond to the embodiment shown in FIG. 5C.

After the aforementioned step S702, step S704 or step S706, the control unit 144 stores the adjustment instruction (step S707). Then, the control unit 144 controls the switching unit 146 to switch to the aperture mode or the focus/zoom mode according to the adjustment instruction (step S708). The adjustment instruction includes, for example, driving and stopping the aperture adjustment module 120 and the lens element adjustment module 130.

Referring to FIG. 12, on the other hand, the processor 118 receives the adjustment instruction of the projection lens 100 via a network or remote control (step S709). Then, the processor 118 reads the adjustment instruction stored by the control unit 144 in step S707 through the electrical contact 116j, so as to learn whether the current state is the aperture mode or the focus/zoom mode (step S710), and the processor 118 controls the actuating element 122 of the aperture adjustment module 120 through the electrical contact 116f or the electrical contact 116h, or control the actuating element (for example, a motor) of the lens element adjustment module 130 through the electrical contact 116f or the electrical contact 116h (step S711). Moreover, the processor 118 reads the sensing signal from the sensing element 126 through the electrical contact 116b or the electrical contact 116c to learn a position of the aperture assembly 112 and reads the sensing signal from the sensing element of the lens element adjustment module 130 to learn a position of the focus/zoom assembly (step S712).

In addition, as shown in FIG. 3, the projection lens 100 of the embodiment may further include a display unit 150, and the display unit 150 may be, for example, a display screen, a state display lamp, or a combination thereof. The display unit 150 is coupled to the switching assembly 140 and used for displaying whether the switching assembly 140 is in the first state or in the second state for the user to view. More specifically, the display unit 150 is coupled to the control unit 144 of the switching assembly 140. For example, the display unit 150 may be an LED display lamp, and when the control unit 144 controls the switching unit 146 to switch to the second state, the LED display lamp of the display unit 150 does not emit light, while when the control unit 144 controls the switching unit 146 to switch to the first state, the LED display lamp of the display unit 150 emits light. In other words, the display unit 150 may not emit light when the projection lens 100 performs aperture adjustment, and emit light when the projection lens 100 performs focusing/zooming adjustment. In another embodiment, the display unit 150 may emit light when the projection lens 100 performs aperture adjustment, and does not emit light when the projection lens 100 performs focusing/zooming adjustment.

In summary, the embodiments of the invention have at least one of following advantages or effects. The projection lens of the embodiment of the invention is provided with a switching assembly, and the switching assembly may be used to switch between the lens element adjustment module and the aperture adjustment module. Accordingly, the lens element adjustment module and the aperture adjustment module may share the electrical contacts of the electrical connection interface of the lens body, so that the projection lens may control both of the aperture adjustment module and the lens element adjustment module through the existing electrical connection interface.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A projection lens, adapted for a projection device, the projection lens comprising:
a lens body, comprising an aperture assembly and a lens element group;
an aperture adjustment module, disposed on the lens body and connected to the aperture assembly, and configured to adjust the aperture assembly;
a lens element adjustment module, disposed on the lens body and connected to the lens element group, and configured to adjust the lens element group; and
a switching assembly, coupled to the aperture adjustment module and the lens element adjustment module, wherein the switching assembly is configured to switch to a first state so that the lens element adjustment module adjusts the lens element group, and the switching assembly is configured to switch to a second state so that the aperture adjustment module group adjusts the aperture assembly.

2. The projection lens according to claim 1, wherein the lens element adjustment module is a zoom module or a focus module.

3. The projection lens according to claim 1, wherein the switching assembly comprises a signal receiving unit, a control unit, and a switching unit, the signal receiving unit is configured to receive a control signal, the control unit is coupled to the signal receiving unit and the switching unit, and the control unit is configured to control the switching unit to switch to the first state or the second state according to the control signal.

4. The projection lens according to claim 1, further comprising a processor coupled to the switching assembly, the lens element adjustment module, and the aperture adjustment module, wherein the processor is configured to control the lens element adjustment module and the aperture adjustment module according to the control signal.

5. The projection lens according to claim 4, wherein the lens body further comprises an electrical connection interface, the electrical connection interface has an electrical contact, the electrical contact is coupled to the processor, the switching assembly is coupled to the processor through the electrical contact, the lens element adjustment module is coupled to the processor through the switching assembly and the electrical contact, and the aperture adjustment module is coupled to the processor through the switching assembly and the electrical contact.

6. The projection lens according to claim 5, wherein the control signal comprises a state signal and an adjustment signal, the switching assembly is configured to switch to the first state or the second state according to the state signal, the switching assembly is further configured to transmit the adjustment signal to the processor, and the processor controls the lens element adjustment module to adjust the lens element group or controls the aperture adjustment module to adjust the aperture assembly according to the adjustment signal.

7. The projection lens according to claim 1, wherein the aperture adjustment module comprises an actuating element and a linkage mechanism, the actuating element is disposed on the lens body and coupled to the switching assembly, and the linkage mechanism is disposed on the lens body and connected between the actuating element and the aperture assembly.

8. The projection lens according to claim 7, wherein the linkage mechanism comprises a first gear, a rack, and a rod, the first gear is connected to the actuating element and meshes with the rack, and the rod is connected between the rack and the aperture assembly.

9. The projection lens according to claim 8, wherein the lens body has an optical axis, the rack is arc-shaped, and the rack extends on the lens body about the optical axis.

10. The projection lens according to claim 8, wherein the lens body further comprises a first rail portion, the rack has a second rail portion, and the first rail portion and the second rail portion slide relative to each other.

11. The projection lens according to claim 8, wherein the rack has a tooth portion at one side and a connecting hole at another side, the tooth portion meshes with the first gear, and the rod is disposed through the connecting hole.

12. The projection lens according to claim 8, wherein the aperture adjustment module comprises a sensing element and a second gear, the second gear is connected to the sensing element and meshes with the rack, and the sensing element is configured to sense a position of the aperture assembly.

13. The projection lens according to claim 1, further comprising a display unit coupled to the switching assembly, wherein the display unit is configured to display whether the switching assembly is in the first state or in the second state.

14. A control method of a projection lens, comprising:
receiving a control signal by a switching assembly, wherein the control signal is a first control signal or a second control signal;
switching the switching assembly to a first state according to the first control signal so that a lens element adjustment module adjusts a lens element group of a lens body; and
switching the switching assembly to a second state according to the second control signal so that an aperture adjustment module adjusts an aperture assembly of the lens body.

15. The control method according to claim 14, wherein the switching assembly comprises a signal receiving unit, a control unit, and a switching unit, and the control method further comprises:
receiving the first control signal or the second control signal by the signal receiving unit;
controlling the switching unit to switch to the first state by the control unit according to the first control signal; and
controlling the switching unit to switch to the second state by the control unit according to the second control signal.

16. The control method according to claim 15, wherein the signal receiving unit receives the control signal by wireless transmission.

17. The control method according to claim 15, wherein the signal receiving unit receives the control signal from an Internet of things device.

18. The control method according to claim 14, wherein the projection lens further comprises a processor, and the control method further comprises:
transmitting the control signal to the processor by the switching assembly; and
controlling the lens element adjustment module to adjust the lens element group or controlling the aperture adjustment module to adjust the aperture assembly by the processor according to the control signal.

19. The control method according to claim 18, wherein the switching assembly receives the control signal from the processor.

20. The control method according to claim 14, wherein the aperture adjustment module comprises a sensing element, and the control method further comprises:
sensing a position of the aperture assembly by the sensing element.

21. The control method according to claim 14, wherein the projection lens further comprises a display unit, and the control method further comprises:
displaying whether the switching assembly is in the first state or in the second state by the display unit.

22. A projection device, comprising:
a light source, configured to provide an illumination beam;
a light valve, configured to convert the illumination beam into an image beam; and
a projection lens, configured to project the image beam out of the projection device, the projection lens comprising:
a lens body, configured to project the image beam, wherein the lens body comprises an aperture assembly and a lens element group;
an aperture adjustment module, disposed on the lens body and connected to the aperture assembly, and configured to adjust the aperture assembly;
a lens element adjustment module, disposed on the lens body and connected to the lens element group, and configured to adjust the lens element group; and
a switching assembly, coupled to the aperture adjustment module and the lens element adjustment module, wherein the switching assembly is configured to switch to a first state so that the lens element adjustment module adjusts the lens element group, and the switching assembly is configured to switch to a second state so that the aperture adjustment module group adjusts the aperture assembly.

23. The projection device according to claim 22, wherein the lens element adjustment module is a zoom module or a focus module.

24. The projection device according to claim 22, wherein the switching assembly comprises a signal receiving unit, a control unit, and a switching unit, the signal receiving unit is configured to receive a control signal, the control unit is coupled to the signal receiving unit and the switching unit, and the control unit is configured to control the switching unit to switch to the first state or the second state according to the control signal.

25. The projection device according to claim 22, wherein the projection lens further comprises a processor, the processor is coupled to the switching assembly, the lens element adjustment module, and the aperture adjustment module, and the processor is configured to control the lens element adjustment module and the aperture adjustment module according to the control signal.

26. The projection device according to claim 25, wherein the lens body further comprises an electrical connection interface, the electrical connection interface has an electrical contact, the electrical contact is coupled to the switching assembly, the switching assembly is coupled to the processor through the electrical contact, the lens element adjustment module is coupled to the processor through the switching assembly and the electrical contact, and the aperture adjustment module is coupled to the processor through the switching assembly and the electrical contact.
